(19) United States
(12) Patent Application Publication
(10) Pub. No.: US 2006/0129896 A1
(43) Pub. Date: Jun. 15, 2006

(54) Account data reconciliation

(75) Inventor: Jakob Rohn, Langhorne, PA (US)

Correspondence Address: RATNERPRESTIA, P O BOX 980, VALLEY FORGE, PA, 19482-0980, US

(73) Assignee: Albridge Solutions, Inc.

(21) Appl. No.: 11/065,233

(22) Filed: Feb. 24, 2005

Related U.S. Application Data
(60) Provisional application No. 60/629,981, filed on Nov. 22, 2004.

(51) Int. Cl. G06F 11/00

(52) U.S. Cl. 714/49

(57) ABSTRACT

A method and apparatus for correcting account data. First data and second data corresponding to an account are received. The first data is compared to the second data to identify any discrepancy between the first and second data. A possible cause of the discrepancy is automatically identified and the discrepancy is selectively corrected by modifying at least one of the first data and the second data in response to the identified possible cause.

### CROSS-REFERENCE TO RELATED APPLICATIONS

This application claims the benefit of priority to U.S. Provisional Patent Application No. 60/629,981, filed on Nov. 22, 2004, the contents of which are incorporated herein by reference.

### FIELD

The invention pertains to processing account data and, more particularly, to identifying a discrepancy in account data.

### BACKGROUND

Financial institutions and financial advisors often manage multiple accounts. Data corresponding to such accounts may be used for performance reporting, data warehousing, and other business purposes.

The account data may be received in multiple forms (e.g., account holdings, account transactions) and from multiple sources (e.g., clearing firms, product providers, data custodians, or a financial institution's own systems). However, if the data is not accurate, the application of such data (e.g., performance reporting, financial planning) may provide inaccurate results. Whether or not there are inaccuracies in data for a particular account, for example, may be determined by comparing two sets of data corresponding to that account. A difference between the two sets of data may indicate that a data set includes an error.

### SUMMARY

In one aspect, the invention comprises receiving first data and second data corresponding to an account. The first data is compared to the second data to identify any discrepancy between the first and second data. A possible cause of the discrepancy is automatically identified and the discrepancy is selectively corrected by modifying at least one of the first data and the second data in response to the identified possible cause.

In another aspect, the invention comprises receiving first data and second data corresponding to an account. The first data is compared to the second data to identify any discrepancy between the first and second data. At least one test is automatically performed to determine a possible cause of the discrepancy. The possible cause is provided to an operator station. Input data is received from the operator station and the discrepancy is selectively corrected in response to the input data.

In another aspect, the invention comprises receiving first data and second data corresponding to an account. The first data is compared to the second data to identify any discrepancy between the first and second data. One of the first and second data is automatically modified in response to the identified discrepancy to reconcile the discrepancy.

In another aspect, the invention comprises storing first and second data corresponding to an account. An inconsistency between the first data and the second data is identified. At least one automated test is performed to determine at least one change to at least one of the first and second data to resolve the discrepancy. The determined at least one change is applied to the at least one of the first data and the second data.

In yet another aspect the invention comprises a system having a memory for storing first data and second data corresponding to an account. A comparator receives the first and second data and compares the first data to the second data to identify a discrepancy between the first and second data. The comparator generates a discrepancy signal based on the identified discrepancy. A possible cause generator receives the discrepancy signal, performs at least one test in response to the discrepancy signal, and generates a possible cause signal identifying a possible cause of the identified discrepancy. A controller selectively corrects the discrepancy in response to the possible cause signal.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a flow chart illustrating a method according to an embodiment of the invention;

FIG. 2 is a functional block diagram of a system according to an embodiment of the invention;

FIG. 3 is a flow chart illustrating a method according to an embodiment of the invention;

FIG. 4 is a flow chart illustrating a method according to an embodiment of the invention;

FIG. 5 is a flow chart illustrating a method according to an embodiment of the invention;

FIG. 6 is a flow chart illustrating a method according to an embodiment of the invention; and

FIG. 7 is a flow chart illustrating a method according to an embodiment of the invention.

### DETAILED DESCRIPTION

Data corresponding to an account (“account data”), such as a financial account, for example, may be used to generate performance metrics or for other purposes (e.g., account valuation). If the account data is inaccurate, the performance metrics may also be inaccurate. It may be possible to determine inaccuracies in account data by comparing one set of data for an account to another set of data for the same account. The differences between the sets of data may indicate inaccuracies.

For accounts having a large number of holdings and/or transactions (e.g., large financial accounts), the number of discrepancies may be large. As used herein, an account encompasses a grouping of one or more holdings. Resolving these discrepancies manually may be a time consuming task and may entail reviewing the different sets of data in view of the identified discrepancies to identify a cause of each discrepancy individually. Once the cause is identified, a corresponding fix or correction may be made to one the data sets that is determined to be erroneous. Embodiments of the invention encompass automatically identifying possible inaccuracies in account data, such as by comparing two sets of data corresponding to the account, automatically identifying a possible cause of the inaccuracies, and then selectively correcting the inaccuracies in response to the identified possible cause.

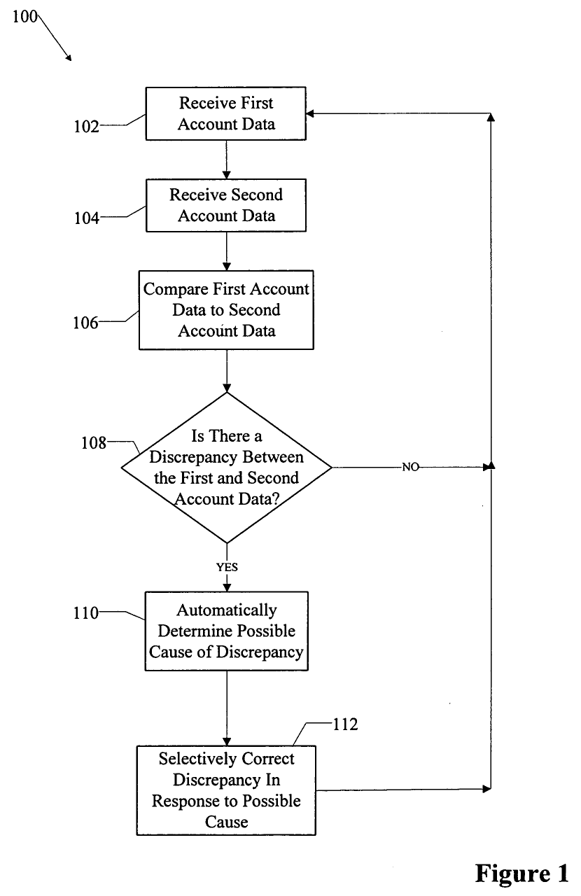

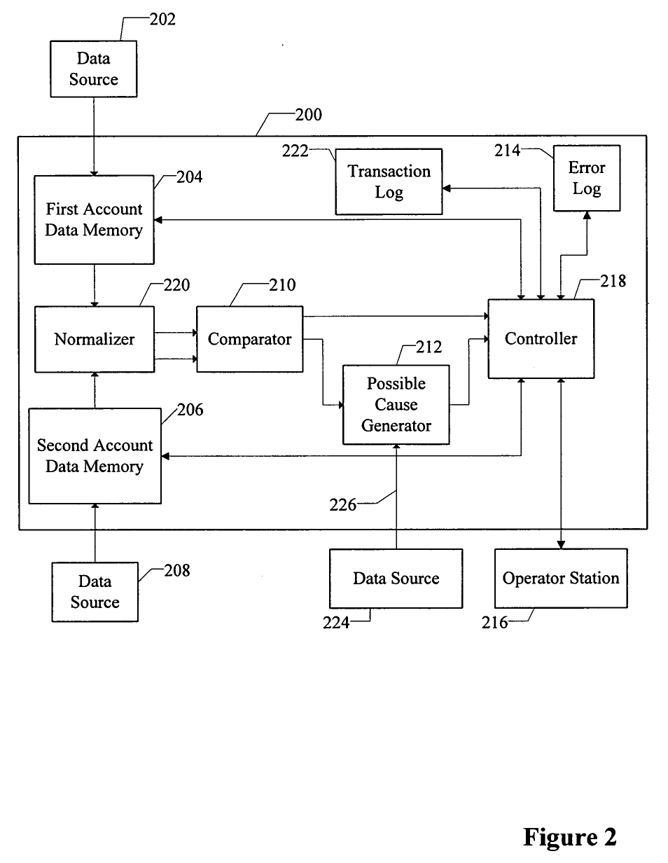

Referring to the drawings, in which like reference numerals indicate like elements, there is shown in FIG. 1 is a flow chart 100 illustrating a method according to an embodiment of the invention. The method of FIG. 1 is described below with reference to the system 200 illustrated in FIG. 2.

The system 200 receives first data corresponding to an account in step 102. The first data is received from a data source 202 and stored in a memory device 204. The system 200 receives second data corresponding to the same account in step 104. The second data is received from a data source 208 and stored in a memory device 206. Although methods according to embodiments of the invention are described as having sequential steps, embodiments of the invention encompass methods where steps are performed in parallel and/or in other sequences.

Embodiments of the invention encompass a single data source providing the first and second data and other embodiments encompass multiple data sources providing the first and second data. In an embodiment of the invention, the data source is an accounting system such as Beta or APL. Embodiments of the invention are not limited to receiving data in a particular format and examples of formats include but are not limited to delimited text files, database files and XML files. Embodiments of the invention encompass a single memory device storing the first and second data and encompass multiple memory devices storing the first and second data.

A comparator 210 compares the first data to the second data in step 106 and determines in step 108 whether or not there is a discrepancy between the first and second data. If there is not a discrepancy, the method returns to steps 102 and 104 to received first and second data corresponding to another account.

If there is a discrepancy as identified in step 108, a possible cause of the identified discrepancy is automatically determined in step 110 by a possible cause generator 212. The discrepancy is then selectively corrected in step 112 by a controller 218 by modifying at least one of the first data and the second data in response to the identified possible cause. In an embodiment of the invention, the system discrepancy is selectively corrected in response to operator authorization. In another embodiment, the discrepancy is not selectively corrected and instead is automatically corrected based on the possible cause.

In an embodiment of the invention, the system 200 comprises a computer including a processor and memory for performing the functions of the elements of the system. For example, the processor may perform the functions of the controller 218, possible cause generator 212, comparator 210 and normalizer 220 in conjunction with one or more memory devices for storing the account data and logs. In another embodiment, the functions of the controller 218, possible cause generator 212, comparator 210 and normalizer 220 are performed by a plurality of microprocessors.

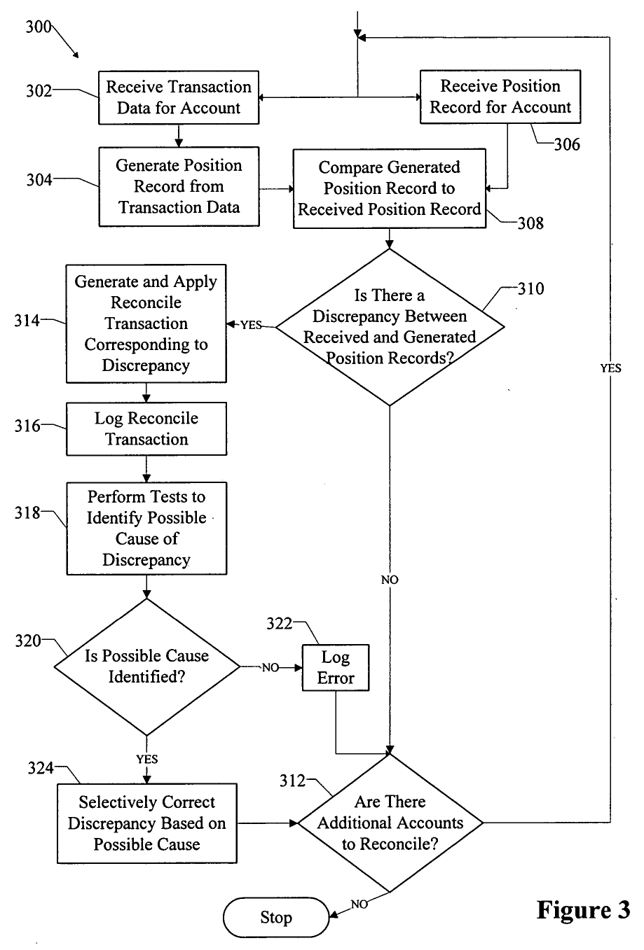

There is shown in FIG. 3 a flow chart 300 illustrating a method according to an embodiment of the invention. The method of FIG. 3 is described below with reference to the system 200 illustrated in FIG. 2.

The first data for an account is received from a data source 202 in step 306. The first data in this embodiment is a position record (the “received position record”) for the account. The received position record identifies the position of each holding in an account at the end of a certain time period. Although described herein with regard to the time period being a day, embodiments of the invention encompass other time periods.

A position record for an account for day X (e.g., the position at the end of the day) is shown in Table 1 below according to an embodiment of the invention. The position record identifies the position at the end of day X for four holdings for an account where the holdings are designated “A,” “B,” “C” and “E.”

TABLE 1
POSITION RECORD - Day X

| Holding | Amount (units) |
|---|---|
| A | 75 |
| B | 50 |
| C | 50 |
| E | 25 |

Table 1 above indicates that the account includes seventy-five (75) units (e.g., shares) of holding A, fifty (50) units of holding B and so forth. A position record for the same account for day X+1 (i.e., the next day) is shown in Table 2 below according to an embodiment of the invention.

TABLE 2
POSITION RECORD - Day X + 1

| Holding | Amount (units) |
|---|---|
| A | 100 |
| B | 50 |
| C | 200 |
| D | 100 |
| E | 50 |

Although the amount of a holding is described herein with regard to units, embodiments of the invention encompass other bases for measuring an amount or value of a holding such as a cash value, for example. The position record shown in Table 2 above identifies the position at the end of day X+1 for five holdings for the account including an additional holding as compared to Day X that is designated “D.”

The second data for the same account is received from a data source 208 in step 302. The second data in this embodiment is transaction data for the account. Transaction data identifies transactions, i.e., debits and credits, corresponding to an account that occur over a period of time. Transaction data corresponding to the account for transactions occurring on Day X+1 is shown in Table 3 below according to an embodiment of the invention. The transaction data identifies each transaction with regard to each holding that occurs during a certain time period, during day X+1 in this example.

TABLE 3
TRANSACTION INFO. - DAY X + 1

| Holding | Source | Type | Amount (units) | Cash Flow |
|---|---|---|---|---|
| B | Data Source X | Sell | −50 | POS |
| B | Data Source Y | Buy | 50 | NEG |
| C | Data Source Z | Buy | 50 | NEG |
| E | Data Source Z | Buy | 10 | NEG |

Table 3 above indicates that four transactions occurred during Day X+1 for the account. Two transactions for holding B and one for each of holdings C and E. The transaction information in Table 3 identifies the source of the transaction information for that transaction, the type of the transaction (all are Buy or Sell in this example), the amount of the transaction (in units in this example) and the effect of each transaction on cash flow. The cash flow indication in the embodiment illustrated in Table 3 indicates either a positive (POS) or a negative (NEG) cash flow. Embodiments of the invention encompass indicating a cash flow amount received from the data source or a cash flow amount calculated based on the Amount and the price of the holding.

In an embodiment of the invention, the data for each day (or other time period) is separately received from a data source. Embodiments of the invention encompass receiving data encompassing multiple time periods from one or more data sources and segregating data from a desired time period from the received data. For example, if transaction data spanning multiple time periods (e.g., days X and X+1) is received from a data source, each transaction may include a corresponding time stamp and data for a desired time period (e.g., day X+1) may be segregated (e.g., by filtered) to generate data for Day X+1 as shown in Table 3.

In the embodiment of the invention shown in FIG. 2, the normalizer 220 converts (or normalizes) the first and second data into a common format for comparison by the comparator 210. The data for a particular period (e.g., day X+1) may be received from a single source or from a plurality of data sources. Data from one source may communicate information in a different format than data from another source. For example, one data source may refer to a “Buy” transaction and another data source may refer to the same type of transaction as a “Purchase” transaction. Embodiments of the invention encompass converting data received from data sources into a common format for processing with data from other sources. For example, transaction codes such as “Buy” and “Purchase” may be mapped to a common transaction code. A transaction code such as “Purchase” may be mapped to a common transaction code of “Buy” and a transaction code of “Distribution” may be mapped to a common transaction code of “Sell.”

The normalizer 220 is not limited to converting transaction codes and generally encompasses devices that convert received data into a common format for comparison with data from other data sources. The transaction data for the account is received in step 302 and the position record for the account is received in step 306. Although the transaction data and the position record correspond to the same account and the same period of time, transaction data is in a different format than a position record and can not be directly compared to a position record.

The transaction data and the position record are normalized to put them in a compatible format for comparison. One or both of the transaction data and the position record are converted (or “normalized”) into a common format for comparison. In the embodiment illustrated in FIGS. 2 and 3, the normalizer 220 converts the transaction data into a position record (the “generated position record”) in step 304.

The normalizer 220 applies the transactions for a period of time relating to each holding in the account to a position record from the previous period of time to generate a generated position record. In this embodiment of the invention, the starting position of holding A is the position on Day X and there are no transactions relating to A during the period. Therefore, the generated position for holding A for Day X+1 is its position on Day X. There are two transactions for holding B on Day X+1. When these two transactions are applied to the position of holding B on Day X (the starting position), the position of holding B on Day X+1 (ending position) is determined to be 50 units. In particular, the position of holding B on Day X was 50. When the Sell of 50 of holding B on Day X+1 is applied to that position a new position of zero units (50−50) is determined. When the Buy of 50 of holding B on Day X+1 is applied to that generated position, a generated position of 50 units (0+50) is generated. The generated positions corresponding to holdings C, D and E are similarly calculated to generate the generated position record for the account as shown in Table 4 below.

TABLE 4
GENERATED POSITION RECORD

| Holding | Day X + 1 Amount (units) |
|---|---|
| A | 75 |
| B | 50 |
| C | 100 |
| D | 0 |
| E | 35 |

Once the first and second data are in a common format, that is, as position records for Day X+1 in this embodiment, the received position record is compared to the generated position record by the comparator 210 in step 308. The comparator 210 in this embodiment of the invention compares the position records by comparing the positions on Day X+1 of each holding. The results of the comparison according to this embodiment of the invention are illustrated in Table 5 indicate discrepancies between the received position record for Day X+1 (PR Day X+1) and the generated position record for Day X+1 (GPR Day X+1).

TABLE 5
COMPARISON OF POSITION RECORD TO
GENERATED POSITION RECORD

| Holding | PR Day X + 1 | GPR Day X + 1 | Discrepancy |
|---|---|---|---|
| A | 100 | 75 | −25 |
| B | 50 | 50 | 0 |
| C | 200 | 100 | −100 |
| D | 100 | 0 | −100 |
| E | 50 | 35 | −15 |

The comparator 210 generates a discrepancy signal that identifies holdings having a discrepancy and the amount of the discrepancy in response to the results of the comparison. If it is determined in step 310 that there is not a discrepancy between the received position record (first data) and the generated position record (first data), the system 200 determines whether there are any additional accounts to reconcile in step 312 and proceeds to received the first and second data for another account if an additional account is identified.

If it is determined in step 310 that there is a discrepancy between the received position record (first data) and the generated position record, in step 314 the system 200 generates a reconcile transaction corresponding to the discrepancy and applies the reconcile transaction to the transaction data. The reconcile transaction is a transaction that is incorporated into the transaction data to reconcile an account having a discrepancy. The reconcile transaction does not necessarily account for or correct the cause of the discrepancy but allows for account reconciliation. Reconcile transactions corresponding to holdings A, C, D and E are incorporated into the transaction data for Day X+1 as illustrated in Table 6 below. The system 200 records an the entry of each transaction in a transaction log 222 and logs the reconcile transaction in the transaction log 222 in step 316.

TABLE 6
TRANSACTION INFO. - DAY X + 1

| Holding | Source | Type | Amount | Cash Flow |
|---|---|---|---|---|
| B | Data | Sell | −50 | POS |
| B | Data | Buy | 50 | NEG |
| C | Data | Buy | 50 | NEG |
| E | Data | Buy | 10 | NEG |
| A | Reconcile | Buy | 25 | NEG |
| C | Reconcile | Buy | 100 | NEG |
| D | Reconcile | Buy | 100 | NEG |
| E | Reconcile | Buy | 15 | NEG |

The reconcile transactions may be Buy or Sell transactions based on whether the discrepancy is negative or positive, respectively. Embodiments of the invention encompass assigning a type to a reconcile transaction based on characteristics of the discrepancy. The position record for Day X in Table 1 did not indicate any units of holding D. The position record for Day X+1 indicated 100 units of holding D. According to an embodiment of the invention, the reconcile transaction for holding D is assigned a transaction type of Initial Position (“Init. Pos.”) as shown in Table 7 below to indicate that the transaction represents an initial position of holding D and that there was not a prior position in holding D.

TABLE 7
TRANSACTION INFO. - DAY X + 1

| | | | | Cash |
|---|---|---|---|---|
| Holding | Source | Type | Amount | Flow |
| B | Data | Sell | −50 | POS |
| B | Data | Buy | 50 | NEG |
| C | Data | Buy | 50 | NEG |
| E | Data | Buy | 10 | NEG |
| A | Reconcile | Buy | 25 | NEG |
| C | Reconcile | Buy | 100 | NEG |
| D | Reconcile | Init. Pos. | 100 | NEG |
| E | Reconcile | Buy | 15 | NEG |

In step 318, the possible cause generator 212 performs one or more automated tests to identify one or more possible causes of each discrepancy. In response to performing the test(s), the possible cause generator 212 generates a possible cause signal indicating identified possible cause(s) of the discrepancy, if any. If it is determined in step 320 that a possible cause of the discrepancy is not identified in step 318, an error is logged in an error log 214 in step 322. If a possible cause is identified by the possible cause generator in 212 in step 318, the discrepancy is selectively corrected by the controller 218 in step 324 in response to the possible cause signal based on the identified possible cause.

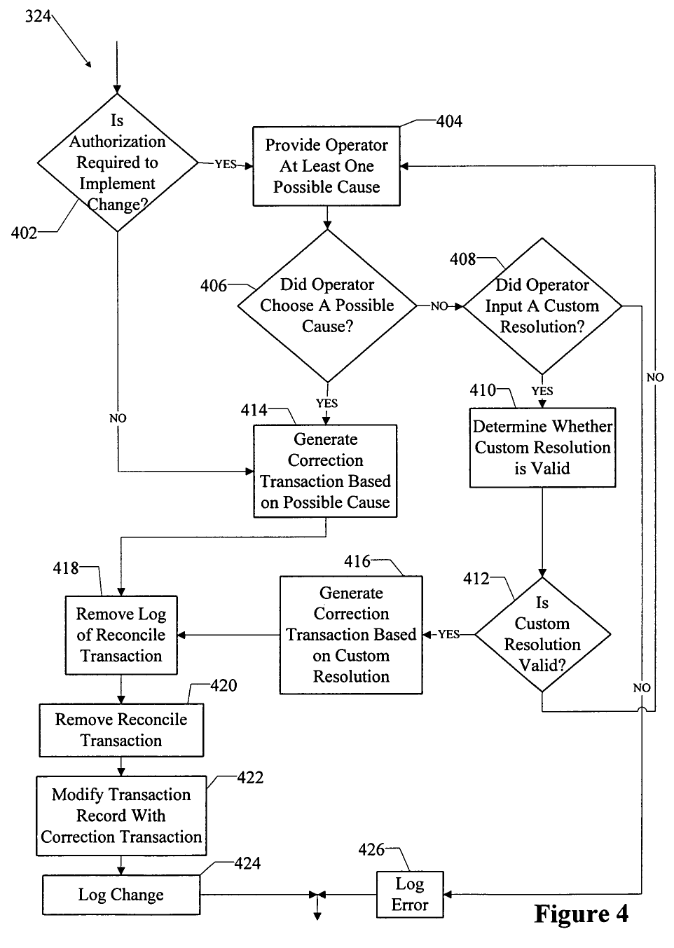

A discrepancy is selectively corrected in step 324 according to a method illustrated by the flow chart 400 in FIG. 4 according to an embodiment of the invention. In step 402, it is determined whether authorization is required to correct a discrepancy. If so, at least one possible cause identified by the possible cause generator 212 in step 318 is provided to an operator station 216 in step 404.

The operator station 216 may display the at least one possible cause for selection by an operator. In an embodiment of the invention, the operator may select one of the possible causes, may create a custom resolution, or may do neither. Input data is received from the operator station 216 indicating a selection by the operator.

If the operator does not select one of the possible causes or create a resolution, the system 202 logs an error in the error log 214 in step 426. If the operator chooses one of the possible causes in step 406, the controller 218 generates a correction transaction based on the selected possible cause in step 414.

If the operator inputs a custom resolution in step 408, the controller 218 determines in step 410 whether the custom resolution is valid. If the custom resolution is valid as determined in step 412, the controller 218 generates a correction transaction based on the custom resolution in step 416. If the custom resolution is not valid as determined in step 412, a corresponding correction transaction is not generated and the possible causes are again provided to the operator in step 404.

In an embodiment of the invention, a custom resolution includes a corresponding resolution value, resolution date and resolution type and the controller 218 determines whether the resolution value, resolution date and resolution type correspond to the discrepancy. If they do not correspond to the discrepancy, the custom cause is determined to be invalid. For example, if an operator enters a transaction for Day X+5 as a custom resolution for a discrepancy corresponding to Day X+1, the controller 218 determines that the custom resolution is invalid because it corresponds to the wrong time period. Similarly, if an operator enters a transaction in the amount of 30 units as a custom resolution for a discrepancy of 10 units, the custom resolution is determined to be invalid because it does not match the amount of the discrepancy.

Once a correction transaction is generated in either steps 414 or 416 based on a possible cause or a custom resolution, respectively, a log of the reconcile transaction is removed from the transaction log 222 in step 414. The reconcile transaction is removed from the transaction data in step 420, the correction transaction is added to the transaction data in step 422, and the entry of the correction transaction is logged in the transaction log 222 in step 424.

The correction transaction is a transaction that is based upon at least one possible cause and corrects a discrepancy. Exemplary correction transactions corresponding to the example presented in Tables 1-7 above are illustrated in Table 8 below. The strikethrough of the reconcile transactions signifies their removal from the transaction data.

TABLE 8
TRANSACTION INFO. - DAY X + 1

| Holding | Source | Type | Amount | Cash Flow |
|---|---|---|---|---|
| B | Data | Sell | −50 | POS |
| B | Data | Buy | 50 | NEG |
| C | Data | Buy | 50 | NEG |
| E | Data | Buy | 10 | NEG |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| A | Correction | Buy | 25 | NEG |
| C | Correction | Corp. Action: 2->1 | 100 | — |
| D | Correction | Init. Action | 100 | NEG |
| E | Correction | Pattern | 5 | NEG |
| E | Correction | Buy | 10 | NEG |

The correction transactions shown in Table 8 are generated as follows according to an embodiment of the invention. With regard to holding A, the comparison between the first and second data resulted in a discrepancy of −25 for holding A as shown in Table 5. The possible cause generator 212 may identify a possible cause of a missing “Buy” transaction or an operator may input a custom resolution of a “Buy transaction to account for the discrepancy. In either case, a correction transaction of a “Buy” of 25 units is added to the transaction record for Day X+1.

With regard to holding B, the comparison between the first and second data resulted in no discrepancy an there is not a corresponding correction transaction. Nevertheless, the possible cause generator 212 may perform automated tests to determine whether a plurality of erroneous transactions cancelled each other to result in a zero discrepancy for the holding.

With regard to holding C, the comparison between the first and second data resulted in a discrepancy of −100 for holding C as shown in Table 5. The discrepancy in this case is twice the amount of the position of C for the previous period (i.e., Day X). The possible cause generator 212 perform automated tests for determining the possible causes based on data in addition to the first and second data. In an embodiment of the invention, one or more additional data sources 224 provide data factored into the tests performed by the possible cause generator 212. In an embodiment of the invention, the system may receive a corporate action data input signal 226 from an additional data source 224. The corporate action data signal indicates corporate actions pertaining the account holdings. For example, with regard to holding C, if a corporate action input indicates that there was a two-for-one split for holding C on Day X+1, the possible cause generator 212 would identify the split as a possible cause of the discrepancy because the discrepancy amount (100) is twice the holding amount for the prior period (100).

With regard to holding D, the comparison between the first and second data resulted in a discrepancy of −100 for holding D as shown in Table 5. As described above, there was no position in holding D for Day X. The discrepancy in this example is determined to be caused by an initial action of a Buy of 100 units of D that were not included in the transaction data.

With regard to holding E, the comparison between the first and second data resulted in a discrepancy of −15 for holding E as shown in Table 5. In an embodiment of the invention, the possible cause generator 212 performed “pattern” recognition tests and generates possible causes based on patterns of prior activity. For example, with regard to holding E, this particular account may include a “Buy” of five (5) units of holding E each month. When a transaction for that patterned amount of five units does not appear in the transaction data when it would otherwise appear for Day X+1, the possible cause generator may identify a missed pattern transaction as a possible cause of the discrepancy. Accordingly, a correction transaction of a Buy of 5 units of E is added to the transaction record for Day X+1.

A discrepancy may be corrected with one or more correction transactions based on one or more possible causes as illustrated in Table 8. The pattern “Buy” of 5 units of holding E only accounts for 5 of the 15 units of the discrepancy. The remaining 10 units are corrected by a correction transaction in the form of a Buy of 10 units of holding E.

The corrections described above with regard to Table 8 were corrections to the transaction data for an account. Embodiments of the invention encompass corrections to sets of account data other than transaction data such as corrections to the position record of an account.

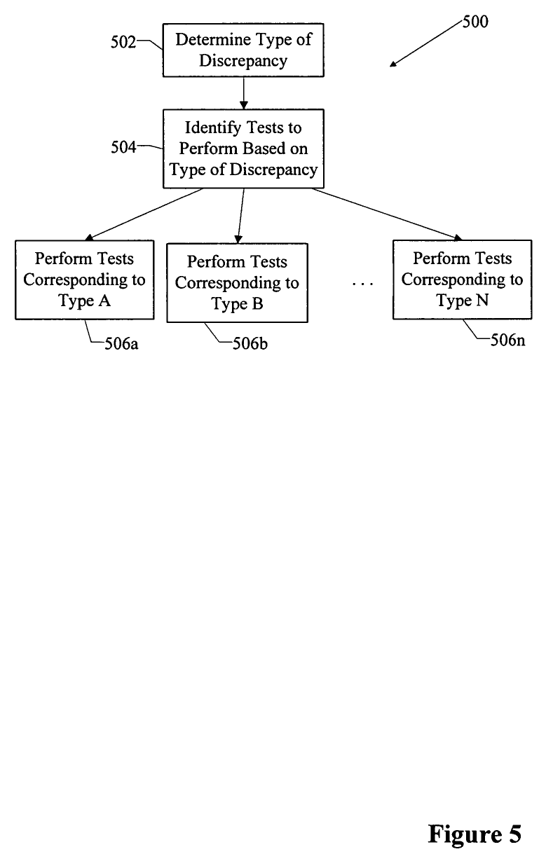

In an embodiment of the invention, one or more possible causes are identified by the possible cause generator 212 by performing at least one test. In an embodiment of the invention, the one or more possible causes are identified according to the method illustrated by the flow chart 500 in FIG. 5. A type of the discrepancy is identified in step 502. In step 504, a plurality of tests are identified corresponding to the type of discrepancy identified in step 502. A different set of tests is performed depending on the type of discrepancy as illustrated by steps 506a through 506n.

In an embodiment of the invention, a plurality of tests are prioritized and the tests are performed in a priority order. In an embodiment of the invention, the priority of a test is determined based on the type of discrepancy.

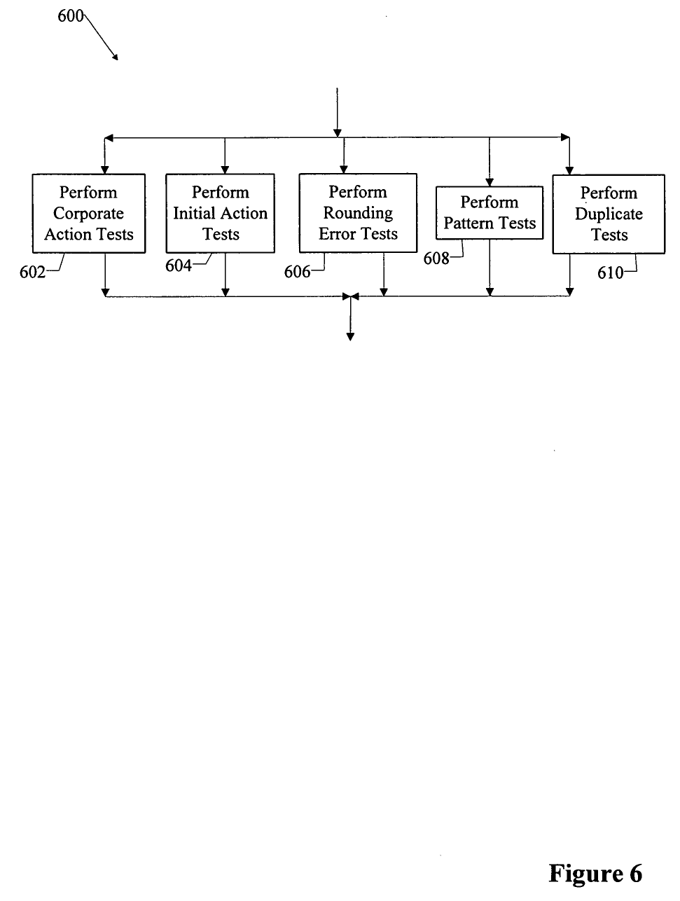

In an embodiment of the invention, a plurality of tests are performed in parallel as illustrated by the flow chart 600 in FIG. 6. Each of several groups 602-608 of tests are performed in parallel. In the embodiment of the invention shown in FIG. 6, each group of tests 602-608 corresponds to a particular type of discrepancy.

In an embodiment of the invention, if the discrepancy type indicates that a corporate action caused the discrepancy, one or more corporate action tests are performed in step 602. An example of a corporate action test was described above with regard to the correction transaction for holding C. Information from one or more additional data sources indicate corporate actions relating to the holdings. The possible cause generator 212 calculates the effect of a corporate action in a number of units of a holding and determines whether this calculated number of units corresponds to a discrepancy. As described above, the number of units resulting from the split corresponded to the number of units of the discrepancy and the split was determined to be the cause of the discrepancy. Other corporate actions such as mergers, name changes, acquisitions, spin-offs, reverse splits, and dividends (cash or units/stock) may similarly be factored by corporate action tests to generate the possible causes.

The correction transaction for holding C had an affect on the cash flow of the account that was different from the cash flow resulting from the reconcile transaction. The split was not a cash transaction whereas the corresponding reconcile transaction of a “Buy” had a negative cash flow affect. If the incorrect “Buy” remained, the performance of the account would be calculated to be lower than its actual performance. Similarly, if the initial position of holding D was the result of a spin-off, the “Buy” of holding D would results in the calculated performance of the account being lower than its actual performance.

In an embodiment of the invention, if the discrepancy type indicates that an initial action caused the discrepancy, one or more initial action tests are performed in step 604. An example of an initial action test was described above with regard to the correction transaction for holding D. There was no position in holding D on Day X and there was a position of 100 units of holding D on Day X+1. This indicates that the discrepancy resulted from an initial position of holding D on Day X+1.

In an embodiment of the invention, a correction transaction is floated back in time to correct a discrepancy. An exemplary application of floating back a correction is to correct an error resulting from transactions and/or position information being received out of order. For example, if a dividend for holding D is received on Day X when there is no position in holding D, the existence of the dividend indicates that there must be a position for holding D prior to when the dividend was received. In a later period (e.g., Day X+1), the initial position of holding D may be identified in the position record. The correction transaction corresponding to an initial “Buy” of holding D may then be floated back to a time preceding Day X (i.e., before the dividend).

In an embodiment of the invention, if the discrepancy type indicates that an rounding error caused the discrepancy, one or more rounding error tests are performed in step 606. If the discrepancy amount as illustrated in FIG. 5 is a small amount (e.g., less than a threshold amount), the possible cause generator 212 generates a possible cause indicating that the discrepancy results from a rounding error.

In an embodiment of the invention, if the discrepancy type indicates that a pattern transaction caused the discrepancy, one or more pattern tests may be performed in step 608. As described above with regard to holding E in Table 8, the tests performed by the possible cause generator 212 may account for a pattern of a transactions for a holding or for an account when determining the possible causes of a discrepancy. For example, a particular account may have a pattern of monthly “Buy” transactions of a particular holding. A discrepancy in the amount of the patterned transaction may result in a missing pattern transaction being identified as a possible cause of the discrepancy. As another example of a pattern causing a discrepancy, a particular holding may be subject to a periodic dividend. The possible cause generator 212 may calculate the amount of that dividend and compare that dividend amount to the discrepancy to determine whether a discrepancy in a particular holding was caused by a missing dividend transaction.

In an embodiment of the invention, if the discrepancy type indicates that a duplicate transaction caused the discrepancy, one or more duplicate tests are performed in step 610. A duplicate test according to an embodiment of the invention is illustrated with reference to Tables 9-11 below.

TABLE 9
POSITION RECORD - Day X

| Holding | Amount (units) |
|---|---|
| B | 850 |

TABLE 10
POSITION RECORD - Day X + 1

| Holding | Amount (units) |
|---|---|
| B | 900 |

TABLE 11
TRANSACTION INFO. - DAY X + 1

| Holding | Source | Type | Amount | Cash Flow |
|---|---|---|---|---|
| B | Data | Buy | 50 | NEG |
| B | Data | Buy | 50 | NEG |
| B | Data | Buy | 50 | NEG |

The position record and transaction information for holding B in Tables 9-11 above indicate that a discrepancy of 50 units in holding B between the position record and transaction information for Day X+1. This results in a reconcile transaction as illustrated in Table 12 below.

TABLE 12
TRANSACTION INFO. - DAY X + 1

| Holding | Source | Type | Amount | Cash Flow |
|---|---|---|---|---|
| B | Data | Buy | 50 | NEG |
| B | Data | Buy | 50 | NEG |
| B | Data | Buy | 50 | NEG |
| B | Reconcile | Sell | −100 | POS |

In an embodiment of the invention, the possible cause generator 212 determines whether there are multiple transactions for the same number of units. In this example, there are three “Buy” transactions of holding B in the amount of 50 units. The possible cause generator then determines whether there is a reconcile transaction for a multiple of that number of units and in the opposite direction. In this case there is a reconcile “Sell” transaction for −100 units which is a multiple of two times the amount of units in the three “Buy” transactions. The possible cause generator 212 may then determine that two of the “Buy” transactions are duplicate transactions and the controller 218 can correct the transaction information by deleting the duplicate transactions as shown in Table 13 below.

TABLE 13
TRANSACTION INFO. - DAY X + 1

| Holding | Source | Type | Amount | Cash Flow |
|---|---|---|---|---|
| B | Data | Buy | 50 | NEG |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |

In the embodiment described above, there were two duplicate transactions. The possible cause engine 212 may similarly detect one or more duplicate transactions where there are N transactions in the same amount X and a reconcile transaction in the amount (N−1)(−X).

The duplicate tests executed by possible cause engine 212 may also detect duplicate reconcile transactions. For example, if a transaction is cancelled before it is executed but the position record is not adjusted to account for the cancellation, duplicate (or matching) reconcile transactions may identify an incorrect position record. For example, the position of a holding R is 100, 200 and 100 on first, second and third periods, respectively, as shown in Table 14 below.

TABLE 14
POSITION RECORD

| | Amount | Amount | Amount |
|---|---|---|---|
| Holding | Period X | Period X + 1 | Period X + 2 |
| B | 100 | 200 | 100 |

If there are no transactions for holding B in the periods, the corresponding reconcile transactions are as shown below in Table 15.

TABLE 15
TRANSACTION INFO. - Reconcile Transactions

| Period | Holding | Source | Type | Amount |
|---|---|---|---|---|
| X + 1 | B | Reconcile | Buy | 100 |
| X + 2 | B | Reconcile | Sell | −100 |

The duplicate tests performed by the possible cause engine 212 identify that the reconcile transactions for periods X+1 and X+2 match. The possible cause engine 212 then generates a possible cause signal identifying an erroneous position for period X+1 as a possible cause of the discrepancy.

Although five types of tests are described above, embodiments of the invention are not limited to only five types of tests or to the types of tests described above.

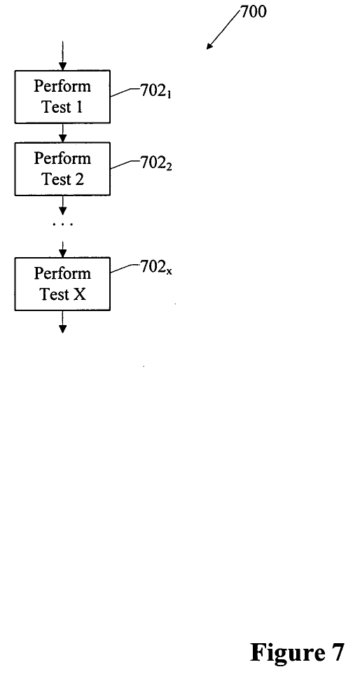

In an embodiment of the invention, a plurality of tests are performed in sequential order as illustrated by the flow chart 700 in FIG. 7. In the embodiment of the invention shown in FIG. 7, a first test 702-1 is performed. If a possible cause is not identified by the first test, the following tests 702-2, -3, . . . are performed in sequential order until a possible cause is identified or until the last test 702-x is performed.

In an embodiment of the invention, a plurality of possible causes are identified and a probability value is assigned to each of the plurality of possible causes. At least one of the plurality of possible causes is selected based on its respective probability value and a discrepancy is corrected by changing at least one of the first data and the second data in response to the selected at least one of the plurality of possible causes. In an embodiment of the invention, the probability values corresponding to possible cause are transmitted by the controller 218 to the operator station 216.

In an embodiment of the invention, a probability value (e.g., 75%) is assigned to a possible cause based on which test identified the possible cause. A test performed to identify a possible cause may have an associated probability. If a particular test identifies a possible cause, the identified possible cause may be assigned the probability value associated with that particular test. If a plurality of probable causes are identified, the probable cause with the highest assigned probability may be selected to resolve a discrepancy. In an embodiment of the invention, a test may have more than one associated probability which may vary depending on the type of discrepancy.

In an embodiment of the invention, discrepancies between more than two data sets corresponding to an account are generated and/or the possible cause generator generates the possible cause of discrepancies based on more than two data sets corresponding to an account. In an embodiment of the invention, a possible cause generator considers the number of data sets having a certain position when generating the possible cause of a discrepancy. For example, if two data sets match each other and a third data set does, the possible cause generator 212 may determine that the third data set is the data set in error.

The foregoing describes the invention in terms of embodiments foreseen by the inventors for which an enabling description was available, although insubstantial modifications of the invention, not presently foreseen may nonetheless represent equivalents thereto.

What is claimed is:

1. A method comprising:
receiving first data corresponding to an account;
receiving second data corresponding to the account;
comparing the first data to the second data to identify a discrepancy between the first data and the second data;
automatically determining a possible cause of the identified discrepancy; and
selectively correcting the discrepancy by modifying at least one of the first data and the second data in response to the identified possible cause.

2. The method according to claim 1 wherein the first data and the second data are represented in a cash format or in a units format.

3. The method according to claim 1 comprising comparing the first data and the second data on a unit basis or a cash basis.

4. The method according to claim 1 comprising normalizing the first data and the second data.

5. The method according to claim 4 wherein the first data comprises a position record, the second data comprises transaction data, and the method comprises generating a position record based on the transaction data and comparing the first data to the generated position record.

6. The method according to claim 1 comprising sequentially performing a plurality of tests to determine the possible cause.

7. The method according to claim 6 wherein the plurality of tests are performed in a priority order.

8. The method according to claim 1 comprising performing a plurality of tests in parallel to determine the possible cause.

9. The method according to claim 1 comprising performing at least one test to determine the possible cause wherein the at least one test comprises at least one of a corporate action test, an initial action test, a rounding error test and a pattern test.

10. The method according to claim 1 comprising identifying a type of the discrepancy and performing at least one test in response to the identified type to determine the possible cause.

11. The method according to claim 1 comprising performing a plurality of tests in response to the identified discrepancy to determine a plurality of possible causes of the identified discrepancy, assigning a probability value to each of the determined plurality of possible causes, selecting at least one of the plurality of possible causes based on its respective probability value, and selectively correcting the discrepancy by changing at least one of the first data and the second data in response to the selected at least one of the plurality of possible causes.

12. The method according to claim 1 wherein the first data and the second data each comprise one of transaction data and a position record.

13. The method according to claim 1 wherein the first data comprises transaction data and the discrepancy is corrected by generating a correction transaction and incorporating the correction transaction into the transaction data.

14. The method according to claim 1 wherein the first data comprises transaction data and the method comprises generating a reconcile transaction and modifying the first data based on the reconcile transaction.

15. The method according to claim 1 wherein the first data comprises transaction data and the method comprises generating a correction transaction based on the determined possible cause and modifying the first data based on the correction transaction.

16. The method according to claim 1 comprising receiving third data corresponding to the account and comparing the first, second and third data to identify the discrepancy.

17. A method comprising:
receiving first data corresponding to an account;
receiving second data corresponding to the account;
comparing the first data to the second data to identify a discrepancy between the first data and the second data;
automatically performing at least one test to determine a possible cause of the discrepancy;
providing an operator station with the possible cause;
receiving input data from the operator station; and
selectively correcting the discrepancy in response to the input data.

18. The method according to claim 17 comprising determining a probability value corresponding to the possible cause and providing the operator station with the probability value.

19. The method according to claim 17 wherein the input data identifies a selection of the possible cause and the method comprises correcting the discrepancy based on the selected possible cause.

20. The method according to claim 17 wherein the input data identifies an operator-identified cause and the method comprises determining whether the operator-identified cause is valid and selectively correcting the discrepancy based on the determination of whether the operator-identified cause is valid.

21. The method according to claim 20 comprising determining whether the operator-identified cause has at least one of resolution value, resolution date, and resolution type that is within a corresponding threshold value.

22. The method according to claim 17 comprising normalizing the first data and the second data.

23. The method according to claim 17 comprising selectively correcting the discrepancy in response to the operator's selection by modifying at least one of the first data and the second data.

24. A method comprising:
receiving first data corresponding to an account;
receiving second data corresponding to the account;
comparing the first data to the second data to identify a discrepancy between the first data and the second data; and
automatically modifying one of the first and second data in response to the identified discrepancy to reconcile the discrepancy.

25. The method according to claim 24 wherein the first data comprises transaction data and the method comprises generating a reconcile transaction in response to the identified discrepancy and modifying the first data by incorporating the reconcile transaction into the first data.

26. The method according to claim 25 comprising:
identifying a probable cause corresponding to the discrepancy;
generating a correction transaction in response to the probable cause;
removing the reconcile transaction from the first data; and
incorporating the correction transaction into the first data.

27. A method comprising:
storing first data corresponding to an account;
storing second data corresponding to the account;
identifying an inconsistency between the first data and the second data;
performing at least one automated test to determine at least one change to at least one of the first and second data to resolve the discrepancy; and
applying the determined at least one change to the at least one of the first data and the second data.

28. The method according to claim 27 wherein the at least one change is automatically applied to the at least one of the first and second data.

29. The method according to claim 27 wherein the at least one change is selectively applied to the at least one of the first and second data.

30. The method according to claim 27 wherein the at least one automated test is automatically performed in response to identification of the inconsistency.

31. The method according to claim 27 wherein the at least one automated test is performed in response to an authorization.

32. A system comprising:
memory for storing first data and second data corresponding to an account;
a comparator for receiving the first and second data, comparing the first data to the second data to identify a discrepancy between the first and second data, and generating a discrepancy signal based on the identified discrepancy;
a possible cause generator for receiving the discrepancy signal, performing at least one test in response to the discrepancy signal, and generating a possible cause signal identifying a possible cause of the identified discrepancy; and
a controller for selectively correcting the discrepancy in response to the possible cause signal.

33. The system according to claim 32 wherein the first and second data are in different formats and the system comprises a normalizer for converting the first and second data into the same format.

34. The system according to claim 32 wherein the controller selectively corrects the discrepancy in response to a probability value corresponding to the probable cause identified by the possible cause signal.

35. The system according to claim 34 wherein the controller compares the probability value to a threshold value and the controller selectively corrects the identified discrepancy based on the comparison to the threshold value.

36. The system according to claim 32 wherein the controller selectively corrects the discrepancy in response to input data received from an operator station.

37. The system according to claim 32 comprising at least one of an error log and a transaction log.

38. A system comprising:
means for storing first data corresponding to an account;
means for storing second data corresponding to the account;
means for comparing the first data to the second data to identify a discrepancy between the first data and the second data;
means for automatically determining a possible cause of the identified discrepancy; and
means for selectively correcting the discrepancy by modifying at least one of the first data and the second data in response to the identified possible cause.

39. The method according to claim 1 comprising means for normalizing the first data and the second data.

40. The method according to claim 1 comprising means for performing a plurality of tests to determine the possible cause.

41. The method according to claim 40 comprising means for performing the plurality of tests in response to at least one of a corresponding priority and a discrepancy type.
